(19) United States
(12) Patent Application Publication
(10) Pub. No.: US 2024/0221729 A1
(43) Pub. Date: Jul. 4, 2024

(54) VOICE RECOGNITION METHOD AND APPARATUS, MEDIUM, AND ELECTRONIC DEVICE

(71) Applicant: Beijing Youzhuju Network Technology Co., Ltd., Beijing (CN)

(72) Inventors: Linhao DONG, Beijing (CN); Zejun MA, Beijing (CN)

(21) Appl. No.: 18/288,531

(22) PCT Filed: May 7, 2022
(86) PCT No.: PCT/CN2022/091477

§ 371 Date: Oct. 26, 2023

(30) Foreign Application Priority Data
Jun. 30, 2021 (CN) 202110738271.7

(51) Int. Cl. G10L 15/16; G10L 15/02

(52) U.S. Cl. CPC G10L 15/16; G10L 15/02

(57) ABSTRACT

The present disclosure provides a voice recognition method and apparatus, a medium, and an electronic device. The method includes: encoding received voice data to obtain an acoustic vector sequence corresponding to the voice data; obtaining, according to the acoustic vector sequence and a first prediction model, an information amount sequence corresponding to the voice data and a first probability sequence corresponding to the voice data; obtaining a second probability sequence according to the acoustic vector sequence and a second prediction model; determining a target probability sequence according to the first probability sequence and the second probability sequence; and determining a target text corresponding to the voice data according to the target probability sequence.

### CROSS-REFERENCE TO RELATED APPLICATION

This application claims priority to Chinese Patent Application No. “202110738271. 7”, entitled with “VOICE RECOGNITION METHOD AND APPARATUS, MEDIUM, AND ELECTRONIC DEVICE” and filed on Jun. 30, 2021, the disclosure of which is incorporated herein by reference in its entirety.

### FIELD

The present disclosure relates to the field of computer technologies, and specifically, to a voice recognition method and apparatus, a medium, and an electronic device.

### BACKGROUND

With the rise of deep learning, various methods that rely entirely on neural networks for end-to-end modeling have gradually emerged. During voice recognition, as input voice data and output text data have different lengths, voice recognition can be performed by an alignment algorithm in a sequence alignment and mapping manner. In the related technology, in order to improve the accuracy of a model in voice recognition, the model is usually trained in a multi-task learning manner. However, during voice recognition based on a model, knowledge accumulated from the multi-task learning in the training process cannot be used, so that it is difficult to achieve the expected accuracy of the model in voice recognition.

### SUMMARY

Providing the summary section of the present disclosure briefly introduces the concepts, and these concepts will be described in detail in the detailed description section later. The summary section of the present disclosure neither intends to identify key or necessary features of the technical solutions claimed, nor to limit the scope of the technical solutions claimed.

In a first aspect, the present disclosure provides a voice recognition method. The method includes:
encoding received voice data to obtain an acoustic vector sequence corresponding to the voice data, wherein the acoustic vector sequence includes an acoustic vector of each audio frame of the voice data;
obtaining, according to the acoustic vector sequence and a first prediction model, an information amount sequence corresponding to the voice data and a first probability sequence corresponding to the voice data, wherein the information amount sequence includes an information amount of each audio frame, and the first probability sequence includes a first text probability distribution of each predicted character corresponding to the voice data;
obtaining a second probability sequence according to the acoustic vector sequence and a second prediction model, wherein the second probability sequence includes a text probability distribution of each audio frame;
determining a target probability sequence according to the first probability sequence and the second probability sequence, wherein the target probability sequence includes a target text probability distribution of each predicted character; and
determining a target text corresponding to the voice data according to the target probability sequence.

Optionally, the obtaining, according to the acoustic vector sequence and a first prediction model, an information amount sequence corresponding to the voice data and a first probability sequence corresponding to the voice data includes:
inputting the acoustic vector sequence to the first prediction model to obtain the information amount sequence; combining the acoustic vectors of the audio frames in the acoustic vector sequence according to the information amount sequence to obtain a character acoustic vector sequence, wherein the character acoustic vector sequence includes an acoustic vector corresponding to each predicted character; and
decoding the character acoustic vector sequence to obtain the first probability sequence.

Optionally, the obtaining a second probability sequence according to the acoustic vector sequence and a second prediction model includes:
inputting the acoustic vector sequence to the second prediction model to obtain a prediction probability distribution of each audio frame; and
for each audio frame, deleting a probability, corresponding to a preset character, in the prediction probability distribution of the audio frame, and normalizing a prediction probability distribution obtained after deletion to obtain a text probability distribution of the audio frame.

Optionally, the determining a target probability sequence according to the first probability sequence and the second probability sequence includes:
combining the text probability distributions of the audio frames in the second probability sequence according to the information amount sequence to obtain a third probability sequence, wherein the third probability sequence includes a second text probability distribution of each predicted character; and
determining the target probability sequence according to the first probability sequence and the third probability sequence.

Optionally, the combining the text probability distributions of the audio frames in the second probability sequence according to the information amount sequence to obtain a third probability sequence includes:
traversing the information amounts in the information amount sequence according to a sequential order, and grouping the audio frames according to cumulative sums of the information amounts to obtain a plurality of audio frame combinations, wherein the cumulative sums of the information amounts corresponding to other audio frame combinations except for the last audio frame combination are the same, and each audio frame combination corresponds to one predicted character; and
for each audio frame combination, determining a weighted sum of the text probability distribution of each audio frame in the audio frame combination as the second text probability distribution of the predicted character corresponding to the audio frame combination, wherein a weight corresponding to each audio frame is determined based on the information amount that the audio frame belongs to the audio frame combination.

Optionally, the determining the target probability sequence according to the first probability sequence and the third probability sequence includes:
for each predicted character, determining a weighted sum of the first text probability distribution of the predicted character in the first probability sequence and the second text probability distribution of the predicted character in the third probability sequence as a target probability distribution of the predicted character.

Optionally, the first prediction model is a Continuous Integrate-and-Fire (CIF) model, and the second prediction model is a Connectionist Temporal Classification (CTC) model.

In a second aspect, a voice recognition apparatus is provided. The apparatus includes:
an encoding module, configured to encode received voice data to obtain an acoustic vector sequence corresponding to the voice data, wherein the acoustic vector sequence includes an acoustic vector of each audio frame of the voice data;
a first processing module, configured to obtain, according to the acoustic vector sequence and a first prediction model, an information amount sequence corresponding to the voice data and a first probability sequence corresponding to the voice data, wherein the information amount sequence includes an information amount of each audio frame, and the first probability sequence includes a first text probability distribution of each predicted character corresponding to the voice data;
a second processing module, configured to obtain a second probability sequence according to the acoustic vector sequence and a second prediction model, wherein the second probability sequence includes a text probability distribution of each audio frame;
a first determining module, configured to determine a target probability sequence according to the first probability sequence and the second probability sequence, wherein the target probability sequence includes a target text probability distribution of each predicted character; and
a second determining module, configured to determine a target text corresponding to the voice data according to the target probability sequence.

In a third aspect, a computer-readable medium is provided, storing a computer program, wherein the program, when executed by a processing apparatus, achieves the steps of any method of the first aspect.

In a fourth aspect, an electronic device is provided, including: a storage apparatus, storing a computer program; and
a processing apparatus, configured to execute the computer program in the storage apparatus to achieve the steps of the any method of the first aspect.

In the above technical solutions, received voice data is encoded to obtain an acoustic vector sequence corresponding to the voice data, and then a first probability sequence and a second probability sequence can be respectively obtained based on the acoustic vector sequence, a first prediction model, and the second prediction model, so that a comprehensive target probability sequence can be obtained according to the first probability sequence and the second probability sequence, and a target text corresponding to the voice data is determined according to the target probability sequence. Thus, due to the above technical solution, the target probability sequence for voice recognition can be determined based on probability sequences respectively output by a plurality of prediction models corresponding to multi-task learning in a training process, and voice recognition and decoding can be performed based on knowledge accumulated by the multi-task learning in the training process, which significantly improves the accuracy and efficiency of voice recognition and enhances the user experience.

Other features and advantages of the present disclosure will be described in detail in the following detailed description section.

### BRIEF DESCRIPTION OF THE DRAWINGS

The above and other features, advantages, and aspects of the various embodiments of the present disclosure will become more apparent by combining the accompanying drawings and referring to the following specific implementations. Throughout the accompanying drawings, identical or similar reference numerals represent identical or similar elements. It should be understood that the accompanying drawings are illustrative, and components and elements may not necessarily be drawn to scale. In the drawings:

FIG. 1 is a flowchart of a voice recognition method according to an implementation of the present disclosure;

FIG. 2 is a flowchart of an exemplary implementation of obtaining, according to an acoustic vector sequence and a first prediction model, an information amount sequence corresponding to the voice data and a first probability sequence corresponding to the voice data;

FIG. 3 is a block diagram of a voice recognition apparatus according to an implementation of the present disclosure; and

FIG. 4 is a schematic structural diagram of an electronic device suitable for being configured to implement the embodiments of the present disclosure.

### DETAILED DESCRIPTION OF EMBODIMENTS

The embodiments of the present disclosure will be described in detail below with reference to the accompanying drawings. Although the accompanying drawings show some embodiments of the present disclosure, it should be understood that the present disclosure can be implemented in various forms, and should not be explained as being limited to the embodiments stated herein. Rather, these embodiments are provided for understanding the present disclosure more thoroughly and completely. It should be understood that the accompanying drawings and embodiments of the present disclosure are only used for illustration, but are not intended to limit the protection scope of the present disclosure.

It should be understood that respective steps recorded in method implementations of the present disclosure can be executed in different orders and/or in parallel. In addition, the method implementations may include additional steps and/or omit the execution of the steps shown. The scope of the present disclosure is not limited in this aspect.

The term “include” and its variants as used herein mean widespread inclusion, namely, “including but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

It should be noted that the concepts such as “first” and “second” mentioned in the present disclosure are only used to distinguish different apparatuses, modules, or units, and are not intended to limit the order or interdependence of the functions performed by these apparatuses, modules, or units.

It should be noted that the modifications of “one” and “plurality” mentioned in the present disclosure are indicative rather than restrictive, and those skilled in the art should understand that unless otherwise explicitly stated in the context, they should be understood as “one or more”.

Messages or names of information exchanged between a plurality of apparatuses in the implementations of the present disclosure are only for illustrative purposes and are not intended to limit the messages or the scope of the information.

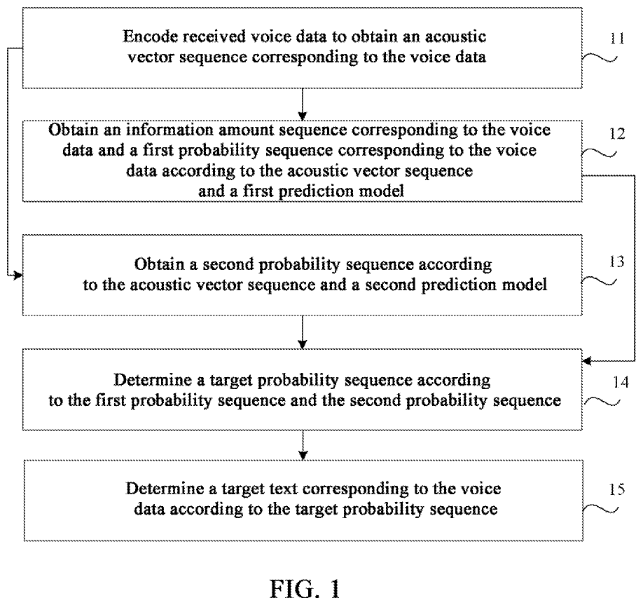

FIG. 1 is a flowchart of a voice recognition method according to an implementation of the present disclosure. As shown in FIG. 1, the method can include:

In step 11, received voice data is encoded to obtain an acoustic vector sequence corresponding to the voice data, wherein the acoustic vector sequence includes an acoustic vector of each audio frame of the voice data.

The received voice data can be encoded through a pre-trained shared encoder, thereby converting the voice data into an acoustic vector representation, namely, obtaining the acoustic vector sequence. Usually, voice data per second can be divided into a plurality of audio frames for data processing based on the audio frames. Exemplarily, the voice data per second can be divided into 100 audio frames for processing. Correspondingly, the audio frames of the voice data are encoded through the shared encoder, and the obtained acoustic vector sequence H can be expressed as:

H: {H₁, H2, . . . , Hu}, where U represents a quantity of the audio frames in the voice data from the beginning of a voice to the end of the voice, that is, a length of the acoustic vector sequence.

In step 12, an information amount sequence corresponding to the voice data and a first probability sequence corresponding to the voice data are obtained according to the acoustic vector sequence and a first prediction model, wherein the information amount sequence includes an information amount of each audio frame, and the first probability sequence includes a first text probability distribution of each predicted character corresponding to the voice data.

As mentioned above, the voice data per second can be divided into 100 audio frames for processing, and the information amount corresponding to each audio frame can be used for representing the number of pieces of information included in the audio frame.

In the embodiments of the present disclosure, if the predicted characters have the same information amounts by default, audio frames corresponding to one predicted character can be determined according to the information amount sequence from left to right, so that the first probability sequence can be obtained based on the acoustic vector of each predicted character.

Exemplarily, the first prediction model can be a Continuous Integrate-and-Fire (CIF) model, and the determined information amount sequence W can be expressed as follows:

$$W : {W}_{1} , {W}_{2} , … , {W}_{U} \} .$$

The first probability sequence P* can be represented as follows:

P*: {P*₁, P*₂, . . . , P*_{M}}, where M represents a total quantity of determined preset characters. In step 13, a second probability sequence is obtained according to the acoustic vector sequence and a second prediction model.

The second probability sequence includes a text probability distribution of each audio frame.

Exemplarily, the second prediction model can be a Connectionist Temporal Classification (CTC) model, which can be understood as a temporal class classification based on a neural network.

As an example, the shared encoder, the first prediction model, and the second prediction model can be trained separately, so that the acoustic vector sequence, the information amount sequence, the first probability sequence, and the second probability sequence can be obtained through the trained models.

As another example, the shared encoder, the first prediction model, and the second prediction model can be jointly subjected to end-to-end training. For example, training data is input to the shared encoder, and vectors output by the shared encoder are respectively input to the first prediction model and the second prediction model. An output of the model can be obtained by decoding an output of the first prediction model. The training of the end-to-end model is achieved by performing multi-task learning on the end-to-end model based on losses of the first prediction model and the second prediction model. Thus, the shared encoder, the first prediction model, and the second prediction model can be obtained through the aforementioned end-to-end training manner, which ensures the matching degree of model parameters between the shared encoder, the first prediction model, and the second prediction model.

In step 14, a target probability sequence is determined according to the first probability sequence and the second probability sequence, wherein the target probability sequence includes a target text probability distribution of each predicted character.

Exemplarily, the first probability sequence includes a probability distribution determined based on the first prediction model and corresponding to the voice data, and the second probability sequence includes a probability distribution determined based on the second prediction model and corresponding to the voice data, so that the accuracy of the target probability sequence can be improved in this step by comprehensively considering the probability distributions respectively determined according to the two prediction models, which provides a data support for subsequent voice recognition.

In step 15, a target text corresponding to the voice data is determined according to the target probability sequence. The target probability sequence includes a target text probability distribution corresponding to each predicted character. As an example, for the target text probability distribution of the first predicted character, a word with the maximum probability is determined as a recognition character of the predicted character according to the target text probability distribution corresponding to each predicted character and a greedy search algorithm. Recognition characters respectively corresponding to the respective predicted characters behind the second predicted character are determined in the same manner according to the target text probability distributions of the respective predicted characters, thus generating the target text according to the recognition characters.

As another example, for the target text probability distribution of the first predicted character, top N words ranked according to their probabilities from large to small according to the target text probability distribution corresponding to each predicted character and a beam search algorithm. For the target text probability distribution of the second predicted character, N candidate recognition characters corresponding to the second predicted character are determined in conjunction with probabilities corresponding to previous candidate recognition characters of the second predicted character. Recognition characters of subsequent predicted characters are determined in the same way, so as to determine the target text corresponding to the whole voice data and having the maximum probability.

In the above technical solutions, received voice data is encoded to obtain an acoustic vector sequence corresponding to the voice data, and then a first probability sequence and a second probability sequence can be respectively obtained based on the acoustic vector sequence, a first prediction model, and the second prediction model, so that a comprehensive target probability sequence can be obtained according to the first probability sequence and the second probability sequence, and a target text corresponding to the voice data is determined according to the target probability sequence. Thus, due to the above technical solution, the target probability sequence for voice recognition can be determined based on probability sequences respectively output by a plurality of prediction models corresponding to multi-task learning in a training process, and voice recognition and decoding can be performed based on knowledge accumulated by the multi-task learning in the training process, which significantly improves the accuracy and efficiency of voice recognition and enhances the user experience.

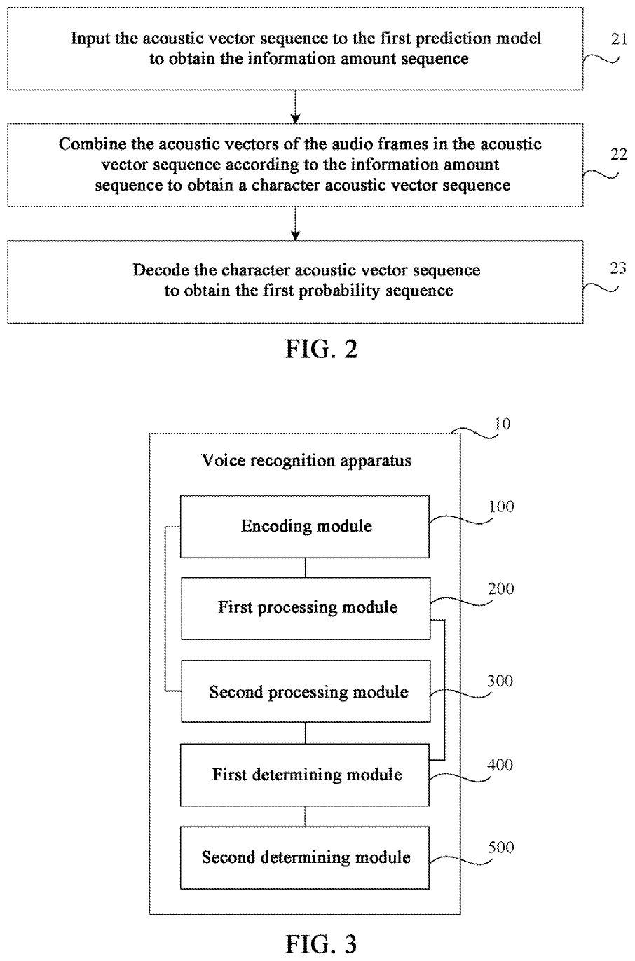

In a possible embodiment, in step 12, an exemplary implementation of obtaining, according to an acoustic vector sequence and a first prediction model, an information amount sequence corresponding to the voice data and a first probability sequence corresponding to the voice data is as follows. As shown in FIG. 2, the step can include:

In step 21, the acoustic vector sequence is input to the first prediction model to obtain the information amount sequence. Exemplarily, the acoustic vector sequence can be input to the first prediction model, the first prediction model

predicts an information amount of each acoustic vector in the acoustic vector sequence. For example, to calculate the information amount corresponding to the acoustic vector of each audio frame in the acoustic vector sequence, a window taking the acoustic vector Hu of the audio frame can be input to a one-dimensional convolutional layer and then input to a sigmoid-activated fully connected layer and to an output unit to obtain the information amount Wu of the audio frame, so as to obtain the information amount sequence.

In step 22, the acoustic vectors of the audio frames in the acoustic vector sequence are combined according to the information amount sequence to obtain a character acoustic vector sequence, wherein the character acoustic vector sequence includes an acoustic vector corresponding to each predicted character.

As mentioned above, in the embodiments of the present disclosure, the information amounts corresponding to the predicted character are the same. Therefore, in the embodiments of the present disclosure, the information amounts in the information amount sequence corresponding to the audio frames can be accumulated from left to right. When a cumulated information amount reaches a preset threshold, it is considered that the audio frames corresponding to the cumulated information amount form a predicted character, and one predicted character corresponds to one or more audio frames. The preset threshold can be set according to an actual application scenario and experience. Exemplarily, the preset threshold can be set to be 1, which is not limited in the present disclosure.

In a possible embodiment, the acoustic vectors of the audio frames in the acoustic vector sequence can be combined according to the information amount sequence in the following way:
obtaining an information amount Wi of an audio frame i in sequence according to a sequential order in the information amount sequence; and
if Wᵢ is less than a preset threshold β, obtaining a next audio frame as a current audio frame, namely, i=i+1, and accumulating the information amounts of traversed audio frames, wherein if a cumulative sum is greater than the preset threshold, it can be considered that a character boundary appears at this time, namely, some of the currently traversed audio frames belong to a current predicted character, and the remaining audio frames belong to a next predicted character.

Exemplarily, if W₁+W₂ is greater than β, it can be considered that there is a character boundary at this time, that is, a part of the first audio frame and a part of the second audio frame can correspond to one predicted character, and a boundary of the predicted character is located in the second audio frame. In this case, the information content of the second audio frame can be divided into two parts, namely, one part belongs to the current predicted character, and the remaining part belongs to the next predicted character.

Correspondingly, the information amount W₂₁, belonging to the current predicted character, among the information amount W₂ of the second audio frame can be expressed as: W₂₁=β−W₁, and the information amount W₂₂ belonging to the next predicted character can be expressed as: W₂₂=W₁−W₂₁.

Afterwards, the information amounts of the audio frames are continued to be traversed, and starting from the remaining information amount of the second audio frame, information amount accumulation is performed, that is, the information amount W₂₂ of the second audio frame and the information amount W₃ of the third audio frame are accumulated until the preset threshold β is obtained, thus obtaining the audio frames corresponding to the next predicted character. The information amounts of the subsequent audio frames are processed combined in the above manner, thus obtaining the respective predicted characters corresponding to the plurality of audio frames.

Based on this, after correspondence relationships between the predicted characters and audio frames in the voice data are determined, for each predicted character, a weighted sum of the acoustic vectors of the audio frames corresponding to the predicted character can be determined to be the acoustic vector corresponding to the predicted character. A weight of the acoustic vector of each audio frame corresponding to the predicted character is the information amount corresponding to the audio frame in the predicted character. If the entire audio frame belongs to the predicted character, the weight of the acoustic vector of the audio frame is the information amount of the audio frame. If a part of the audio frame belongs to the predicted character, the weight of the acoustic vector of the audio frame is the information amount of this part of the audio frame.

As mentioned in the example above, if the first predicted character includes a part of the first audio frame and a part of the second audio frame, the acoustic vector C₁ corresponding to the predicted character can be expressed as:

$${C}_{1} = {W}_{1} * {H}_{1} + {W}_{21} * {H}_{2} .$$

As another example, if the second predicted character includes a part of the second audio frame and the third audio frame, the acoustic vector C₂ corresponding to the predicted character can be expressed as:

$${C}_{2} = {W}_{22} * {H}_{2} + {W}_{3} * {H}_{3} .$$

Therefore, the acoustic vectors of the audio frames in the acoustic vector sequence are combined according to the information amount sequence to obtain a character acoustic vector sequence, so as to process each predicted character. In step 23, the character acoustic vector sequence is decoded to obtain the first probability sequence. Exemplarily, if a character acoustic vector corresponding to each predicted character can be obtained by the manner shown above, the character acoustic vector can be decoded based on a decoder to obtain the first text probability distribution corresponding to each predicted character, that is, a probability that the predicted character is recognized as respective candidate characters.

Therefore, through the above technical solution, the acoustic vectors of the audio frames can be combined based on the information amount of the audio frames to obtain the character acoustic vector corresponding to each predicted character. Voice data corresponding to the audio frame level representation can be mapped to a character level representation, which can be applicable to a voice recognition scenario of any length of voice data and expand the scope of usage of the voice recognition method. Moreover, in the above technical solution, the process of combining the acoustic vectors is determined in a weighted sum manner, without a complex calculation process. Therefore, based on simplifying the voice recognition methods, the processing efficiency of a voice recognition algorithm can be improved, providing an effective data support for subsequent character determination.

In a possible embodiment, in step 13, an exemplary implementation of obtaining a second probability sequence according to the acoustic vector sequence and a second prediction model is as follows. The step can include:

The acoustic vector sequence is input to the second prediction model to obtain a prediction probability distribution of each audio frame.

The second prediction model can be a CTC model. In the prediction model, a text sequence with any length can be determined for an acoustic vector sequence with a given length. In the prediction model, there will be an alignment sequence corresponding to the input acoustic vector sequence, and a length of the alignment sequence is the same as that of the acoustic vector sequence. Mapping to the text sequence is achieved through the alignment sequence. Correspondingly, in the embodiments of the present disclosure, a probability distribution on each dimension before the acoustic vector sequence is mapped to the alignment sequence can be determined to be the prediction probability distribution of the audio frame in the dimension.

For each audio frame, a probability, corresponding to a preset character, in the prediction probability distribution of the audio frame is deleted, and a prediction probability distribution obtained after deletion is normalized to obtain a text probability distribution corresponding to the audio frame.

In order to ensure the accuracy of combining consecutive identical characters during outputting from the alignment sequence to the text sequence, null characters are introduced into the CTC model. The null characters have no meaning and will be removed when they are mapped to the output text sequence. When duplicate characters are combined in the CTC model, consecutive duplicate characters between the null characters will be combined, and the duplicate characters separated by the null characters will not be combined, thus ensuring the accuracy of a recognized text obtained by voice recognition.

In the embodiments of the present disclosure, there is no prediction probability for the null characters in the first prediction model. Correspondingly, the prediction probability distribution in the second prediction model can be processed in the following way to ensure the consistency between a prediction result of the first prediction model and a prediction result of the second prediction model. Exemplarily, for each audio frame, probabilities corresponding to the null characters in the probability distribution corresponding to that audio frame can be deleted, thereby reserving the probability distributions of real characters corresponding to the audio frame. After the above probabilities are deleted for each audio frame, a probability distribution sum corresponding to the audio frame is not necessarily the same, so that the prediction probability distribution after the deletion of the probability of the preset character can be normalized.

Exemplarily, a prediction probability distribution for audio frame K is{ϵ: p₁; s₁: p₂; s₂: p₃; . . . ; sₙ₋₁: pₙ},
where a cumulative sum of p₁, p₂, and pₙ is 1, and each audio frame corresponds to n character dimensions. The n characters include one null character ϵ and n−1 real characters, so ϵ:P₁ in the prediction probability distribution can be deleted, and the probabilities of the remaining corresponding real characters are normalized:

$$P ’ i = {p}_{i} / ( 1 - {p}_{1} ) , i = 2 , 3 , , , n .$$

A second probability sequence P′ can be expressed as follows: P′: {P′₁, P′₂, . . . , P′ₙ}.

Therefore, through the above technical solutions, the prediction probability distribution corresponding to each audio frame can be obtained through the second prediction model. At the same time, the prediction probability distribution can also be processed to delete its corresponding invalid character and obtain the probability distribution, corresponding to the real characters, of each audio frame, which ensures the consistency of the corresponding characters in the first probability distribution obtained by the first prediction model, improves the unified standard for subsequent voice recognition based on the first probability sequence and the second probability sequence, and ensures that the benchmark for voice recognition is the same, thus improving the accuracy of voice recognition to a certain extent.

In a possible embodiment, an exemplary implementation of determining a target probability sequence according to the first probability sequence and the second probability sequence is as follows. The step can include:

The text probability distributions of the audio frames in the second probability sequence according to the information amount sequence are combined to obtain a third probability sequence, wherein the third probability sequence includes a second text probability distribution of each predicted character.

As mentioned above, the first probability sequence includes the first text probability distribution of each predicted character, and the second probability sequence includes the text probability distribution of each audio frame. In order to unify the first text probability distribution and the text probability distribution into probability distributions of representations in the same level, in the embodiments of the present disclosure, the text probability distributions of the audio frames in the sequence probability sequence can be combined based on the information amount sequence, so as to convert the second probability sequence into a probability distribution corresponding to a predicted character level, namely, the third probability sequence.

Exemplarily, the exemplary implementation of combining the text probability distributions of the audio frames in the second probability sequence according to the information amount sequence to obtain a third probability sequence is as follows. The step can include:

the information amounts in the information amount sequence are traversed according to a sequential order, and the audio frames are grouped according to cumulative sums of the information amounts to obtain a plurality of audio frame combinations, wherein the cumulative sums of the information amounts corresponding to other audio frame combinations except for the last audio frame combination are the same, and each audio frame combination corresponds to one predicted character.

In this step, respective audio frames belonging to the same audio frame combination can be determined in the above manner of combining the acoustic vectors of the audio frames in the acoustic vector sequence according to the information sequence, which will not be described in detail here.

For each audio frame combination, a weighted sum of the text probability distribution of each audio frame in the audio frame combination is determined to be the second text probability distribution of the predicted character corresponding to the audio frame combination, wherein a weight corresponding to each audio frame is determined based on the information amount that the audio frame belongs to the audio frame combination.

After an audio frame combination is determined, the second text probability distribution of the predicted character corresponding to the audio frame combination can be determined according to the weight corresponding to each audio frame in the audio frame combination. Exemplarily, the weight corresponding to the audio frame can be the information amount corresponding to the audio frame in the audio frame combination to which the audio frame belongs, that is, the information amount corresponding to the predicted character mentioned above. The weight determining manner for audio frames, all or part of which belong to an audio frame combination, has been described in detail above, which will not be described in detail here.

As the example above, for the first audio frame combination, the second text probability distribution P^{#}₁ of the predicted characters corresponding to the audio frame combination can be determined in the following way:

$${{{P}_{1}^{\#} = {W}_{1} * P ’}_{1} + {W}_{21} * P ’}_{2} .$$

As another example, for the second audio frame combination, which includes a part of the second audio frame and the third audio frame, the second text probability distribution P #2 of the predicted characters corresponding to the audio frame combination can be expressed as:

$${{{P}_{2}^{\#} = {W}_{22} * P ’}_{2} + {W}_{3} * P ’}_{3} .$$

Other audio frame combinations can be processed in the same way, so as to obtain the second text probability distributions of the predicted characters corresponding to the respective audio frame combinations. The obtained third probability sequence P #can be expressed as:

$${P}^{\#} : \{ {P}_{1}^{\#} , {P}_{2}^{\#} , … , {P}_{M}^{\#} \} .$$

Therefore, through the above technical solutions, the text probability distributions of the audio frames in the second probability sequence can be combined based on the information amount sequence. The probability distribution of the audio frame level is converted to the probability distribution of the predicted character level through the information amount of each audio frame, which achieves conversion from the audio frame to the predicted character and is applicable to the voice recognition process of voice data with any length, to ensure the accuracy and reliability of conversion from an audio frame sequence to a character sequence and ensure the accuracy of the third probability sequence, thus providing a reliable data support for subsequent determination of the target probability sequence and voice recognition.

Afterwards, the target probability sequence is determined according to the first probability sequence and the third probability sequence.

In this embodiment, both the first probability sequence and the third probability sequence determined are distributions for text prediction for each predicted character. Therefore, a comprehensive distribution can be determined based on two probability distributions corresponding to the same level, which can include both information content related features of each audio frame determined by the first prediction model and the text probability distribution of each audio frame determined by the second prediction model, ensuring the comprehensiveness of features in the target probability sequence.

In a possible embodiment, the exemplary implementation of determining the target probability sequence according to the first probability sequence and the third probability sequence is as follows. The step can include:

For each predicted character, a weighted sum of the first text probability distribution of the predicted character in the first probability sequence and the second text probability distribution of the predicted character in the third probability sequence is determined to be a target probability distribution of the predicted character.

In this embodiment, the first text probability distribution and the second text probability distribution of each output predicted character are interpolated. For each predicted character i, there is:

$${P}_{i} = P * i + λ * {P}_{i}^{\#} .$$

Therefore, through the above technical solutions, during the recognition of the input voice data, the text prediction probability determined for the character level and the text prediction probability determined for the audio frame level can be combined to introduce the knowledge accumulated through multi-task learning of the training process in the voice recognition and decoding process. On the one hand, the accuracy of voice recognition can be significantly improved with lower computational complexity; and on the other hand, the consistency between knowledge in the voice recognition process and knowledge in the training process can be ensured, and the matching between the accuracy of voice recognition based on a trained model and the accuracy of training can be ensured, thus further improving the efficiency of voice recognition and the user experience.

The present disclosure further provides a voice recognition apparatus. As shown in FIG. 3, the apparatus 10 includes: an encoding module 100, configured to encode received voice data to obtain an acoustic vector sequence corresponding to the voice data, wherein the acoustic vector sequence includes an acoustic vector of each audio frame of the voice data;
a first processing module 200, configured to obtain, according to the acoustic vector sequence and a first prediction model, an information amount sequence corresponding to the voice data and a first probability sequence corresponding to the voice data, wherein the information amount sequence includes an information amount of each audio frame, and the first probability sequence includes a first text probability distribution of each predicted character corresponding to the voice data;
a second processing module 300, configured to obtain a second probability sequence according to the acoustic vector sequence and a second prediction model, wherein the second probability sequence includes a text probability distribution of each audio frame;
a first determining module 400, configured to determine a target probability sequence according to the first probability sequence and the second probability sequence, wherein the target probability sequence includes a target text probability distribution of each predicted character; and
a second determining module 500, configured to determine a target text corresponding to the voice data according to the target probability sequence.

Optionally, the first processing module includes:
a first inputting submodule, configured to input the acoustic vector sequence to the first prediction model to obtain the information amount sequence;
a first combination submodule, configured to combine the acoustic vectors of the audio frames in the acoustic vector sequence according to the information amount sequence to obtain a character acoustic vector sequence, wherein the character acoustic vector sequence includes an acoustic vector corresponding to each predicted character; and
a decoding submodule, configured to decode the character acoustic vector sequence to obtain the first probability sequence.

Optionally, the second processing module includes:
a second inputting submodule, configured to input the acoustic vector sequence to the second prediction model to obtain a prediction probability distribution of each audio frame; and
a processing submodule, configured to: for each audio frame, delete a probability, corresponding to a preset character, in the prediction probability distribution of the audio frame, and normalize a prediction probability distribution obtained after deletion to obtain a text probability distribution of the audio frame.

Optionally, the second determining module includes:
a second combination submodule, configured to: combine the text probability distributions of the audio frames in the second probability sequence according to the information amount sequence to obtain a third probability sequence, wherein the third probability sequence includes a second text probability distribution of each predicted character; and a first determining submodule, configured to determine the target probability sequence
according to the first probability sequence and the third probability sequence.

Optionally, the second combination submodule includes:
a grouping submodule, configured to: traverse the information amounts in the information amount sequence according to a sequential order, and group the audio frames according to cumulative sums of the information amounts to obtain a plurality of audio frame combinations, wherein
the cumulative sums of the information amounts corresponding to other audio frame combinations except for the last audio frame combination are the same, and each audio frame combination corresponds to one predicted character; and
a second determining submodule, configured to: for each audio frame combination, determine a weighted sum of the text probability distribution of each audio frame in the audio frame combination to be the second text probability distribution of the predicted character corresponding to the audio frame combination, wherein a weight corresponding to each audio frame is determined based on the information amount that the audio frame belongs to the audio frame combination.

Optionally, the first determining submodule comprises:
for each predicted character, determine a weighted sum of the first text probability distribution of the predicted character in the first probability sequence and the second text probability distribution of the predicted character in the third probability sequence to be a target probability distribution of the predicted character.

Optionally, the first prediction model is a CIF model, and the second prediction model is a CTC model.

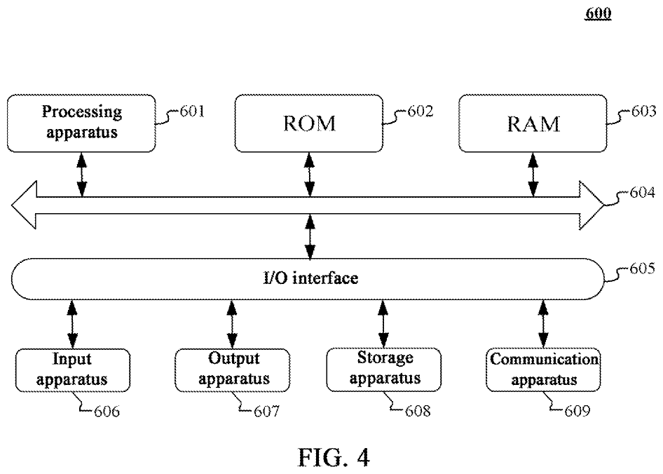

Reference is now made to FIG. 4 below, which illustrates a schematic structural diagram of an electronic device (namely, a terminal device or a server in FIG. 1) 600 suitable for implementing the embodiments of the present disclosure. The terminal device in the embodiments of the present disclosure may include, but is not limited to, a mobile phone, a laptop, a digital broadcast receiver, a Personal Digital Assistant (PDA), a Portable Android Device (PAD), a Portable Media Player (PMP), a mobile terminal such as a vehicle-mounted terminal (for example, a vehicle-mounted navigation terminal), and a fixed terminal such as digital television (TV) and a desktop computer. The electronic device shown in FIG. 4 is only an example and should not impose any limitations on the functionality and scope of use of the embodiments of the present disclosure.

As shown in FIG. 4, the electronic device 600 may include a processing apparatus (such as a central processing unit and graphics processor) 601 that can perform various appropriate actions and processing according to programs stored in a Read-Only Memory (ROM) 602 or loaded from a storage apparatus 608 to a Random Access Memory (RAM) 603. Various programs and data required for operations of the electronic device 600 may also be stored in the RAM 603.

The processing apparatus 601, the ROM 602, and the RAM 603 are connected to each other through a bus 604. An Input/Output (I/O) interface 605 is also connected to a bus 604.

Usually, following apparatuses can be connected to the I/O interface 605: an input apparatus 606 including a touch screen, a touchpad, a keyboard, a mouse, a camera, a microphone, an accelerometer, a gyroscope, and the like; an output apparatus 607 including a Liquid Crystal Display (LCD), a speaker, a vibrator, and the like; a storage apparatus 608 including a magnetic tape, a hard disk drive, and the like; and a communication apparatus 609. The communication apparatus 609 can allow the electronic device 600 to wirelessly or wiredly communicate with other devices to exchange data. Although FIG. 4 shows the electronic device 600 with multiple apparatuses, it should be understood that the electronic device 600 is not required to implement or have all the apparatuses shown, and can alternatively implement or have more or fewer apparatuses.

Particularly, according to the embodiments of the present disclosure, the process described in the reference flowchart above can be implemented as a computer software program. For example, the embodiments of the present disclosure include a computer program product, including a computer program carried on a non-transitory computer-readable medium, and the computer program includes program codes used for performing the methods shown in the flowcharts. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the methods of the embodiments of the present disclosure are executed.

It should be noted that the computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard disk drive, a RAM, a ROM, an Erasable Programmable Read Only Memory (EPROM) or flash memory, an optical fiber, a Compact Disc Read-Only Memory (CD-ROM), an optical storage device, a magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including but not limited to: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but are not limited to: a wire, an optical cable, a Radio Frequency (RF), and the like, or any suitable combination of the above.

In some implementations, clients and servers can communicate using any currently known or future developed network protocol such as a Hyper Text Transfer Protocol (HTTP), and can intercommunicate and be interconnected with digital data in any form or medium (for example, a communication network). Examples of the communication network include a Local Area Network (LAN), a Wide Area Network (WAN), an internet (such as an Internet), a point-to-point network (such as an ad hoc point-to-point network, and any currently known or future developed network.

The computer-readable medium may be included in the electronic device or exist alone and is not assembled into the electronic device.

The above computer-readable medium carries one or more programs. When the above one or more programs are executed by the electronic device, the electronic device is caused to: encode received voice data to obtain an acoustic vector sequence corresponding to the voice data, wherein the acoustic vector sequence includes an acoustic vector of each audio frame of the voice data; obtain, according to the acoustic vector sequence and a first prediction model, an information amount sequence corresponding to the voice data and a first probability sequence corresponding to the voice data, wherein the information amount sequence includes an information amount of each audio frame, and the first probability sequence includes a first text probability distribution of each predicted character corresponding to the voice data; obtain a second probability sequence according to the acoustic vector sequence and a second prediction model, wherein the second probability sequence includes a text probability distribution of each audio frame; determine a target probability sequence according to the first probability sequence and the second probability sequence, wherein the target probability sequence includes a target text probability distribution of each predicted character; and determine a target text corresponding to the voice data according to the target probability sequence.

Computer program codes for performing the operations of the present disclosure may be written in one or more programming languages or a combination thereof. The above programming languages include but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that, each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The modules described in the embodiments of the present disclosure can be implemented through software or hardware. The name of the module does not constitute a limitation on the module itself. For example, the encoding module can also be described as “a module that encodes received voice data to obtain an acoustic vector sequence corresponding to the voice data”.

The functions described herein above may be performed, at least in part, by one or a plurality of hardware logic components. For example, nonrestrictively, example hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents. According to one or more embodiments of the present disclosure, Example 1 provides a voice recognition method. The method includes:
encoding received voice data to obtain an acoustic vector sequence corresponding to the voice data, wherein the acoustic vector sequence includes an acoustic vector of each audio frame of the voice data; obtaining, according to the acoustic vector sequence and a first prediction model, an information amount sequence corresponding to the voice data and a first probability sequence corresponding to the voice data, wherein the information amount sequence includes an information amount of each audio frame, and the first probability sequence includes a first text probability distribution of each predicted character corresponding to the voice data;
obtaining a second probability sequence according to the acoustic vector sequence and a second prediction model, wherein the second probability sequence includes a text probability distribution of each audio frame;
determining a target probability sequence according to the first probability sequence and the second probability sequence, wherein the target probability sequence includes a target text probability distribution of each predicted character; and
determining a target text corresponding to the voice data according to the target probability sequence.

According to one or more embodiments of the present disclosure, Example 2 provides the method according to Example 1, the obtaining, according to the acoustic vector sequence and a first prediction model, an information amount sequence corresponding to the voice data and a first probability sequence corresponding to the voice data includes:
inputting the acoustic vector sequence to the first prediction model to obtain the information amount sequence; combining the acoustic vectors of the audio frames in the acoustic vector sequence according to the information amount sequence to obtain a character acoustic vector sequence, wherein the character acoustic vector sequence includes an acoustic vector corresponding to each predicted character; and
decoding the character acoustic vector sequence to obtain the first probability sequence.

According to one or more embodiments of the present disclosure, Example 3 provides the method according to Example 1, the obtaining a second probability sequence according to the acoustic vector sequence and a second prediction model includes:
inputting the acoustic vector sequence to the second prediction model to obtain a prediction probability distribution of each audio frame; and
for each audio frame, deleting a probability, corresponding to a preset character, in the prediction probability distribution of the audio frame, and normalizing a prediction probability distribution obtained after deletion to obtain a text probability distribution of the audio frame.

According to one or more embodiments of the present disclosure, Example 4 provides the method according to Example 1, the determining a target probability sequence according to the first probability sequence and the second probability sequence includes:
combining the text probability distributions of the audio frames in the second probability sequence according to the information amount sequence to obtain a third probability sequence, wherein the third probability sequence includes a second text probability distribution of each predicted character; and
determining the target probability sequence according to the first probability sequence and the third probability sequence. According to one or more embodiments of the present disclosure, Example 5 provides the method according to Example 4, the combining the text probability distributions of the audio frames in the second probability sequence according to the information amount sequence to obtain a third probability sequence includes:
traversing the information amounts in the information amount sequence according to a sequential order, and grouping the audio frames according to cumulative sums of the information amounts to obtain a plurality of audio frame combinations, wherein the cumulative sums of the information amounts corresponding to other audio frame combinations except for the last audio frame combination are the same, and each audio frame combination corresponds to one predicted character; and
for each audio frame combination, determining a weighted sum of the text probability distribution of each audio frame in the audio frame combination o be the second text probability distribution of the predicted character corresponding to the audio frame combination, wherein a weight corresponding to each audio frame is determined based on the information amount that the audio frame belongs to the audio frame combination.

According to one or more embodiments of the present disclosure, Example 6 provides the method according to Example 4, the determining the target probability sequence according to the first probability sequence and the third probability sequence includes: for each predicted character, determining a weighted sum of the first text probability distribution of the predicted character in the first probability sequence and the second text probability distribution of the predicted character in the third probability sequence as a target probability distribution of the predicted character.

According to one or more embodiments of the present disclosure, Example 7 provides the method according to any one of Examples 1 to 6, the first prediction model is a CIF model, and the second prediction model is a CTC model.

According to one or more embodiments of the present disclosure, Example 8 provides a voice recognition apparatus, including:
an encoding module, configured to encode received voice data to obtain an acoustic vector sequence corresponding to the voice data, wherein the acoustic vector sequence includes an acoustic vector of each audio frame of the voice data;
a first processing module, configured to obtain, according to the acoustic vector sequence and a first prediction model, an information amount sequence corresponding to the voice data and a first probability sequence corresponding to the voice data, wherein the information amount sequence includes an information amount of each audio frame, and the first probability sequence includes a first text probability distribution of each predicted character corresponding to the voice data;
a second processing module, configured to obtain a second probability sequence according to the acoustic vector sequence and a second prediction model, wherein the second probability sequence includes a text probability distribution of each audio frame;
a first determining module, configured to determine a target probability sequence according to the first probability sequence and the second probability sequence, wherein the target probability sequence includes a target text probability distribution of each predicted character; and
a second determining module, configured to determine a target text corresponding to the voice data according to the target probability sequence.

According to one or more embodiments of the present disclosure, Example 9 provides a computer-readable medium, storing a computer program. The program, when executed by a processing apparatus, executes the steps of the method according to any one of Examples 1 to 7.

According to one or more embodiments of the present disclosure, Example 10 provides an electronic device, including: a storage apparatus, storing a computer program; and
a processing apparatus, configured to execute the computer program in the storage apparatus to achieve the steps of the method according to any one of Examples 1 to 7.

The above description is only for explaining the preferred embodiments of the present disclosure and technical principles used in the embodiments. Those skilled in the art should understand that the scope of disclosure referred to in the present disclosure is not limited to the technical solutions formed by specific combinations of the aforementioned technical features, but also covers other technical solutions formed by any combinations of the aforementioned technical features or their equivalent features without departing from the concept of the above disclosure, for example, a technical solution formed by replacing the above features with (but not limited to) technical features with similar functions disclosed in the present disclosure.

In addition, although various operations are depicted in a specific order, this should not be understood as requiring these operations to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. On the contrary, the specific features and actions described above are only exemplary forms for implementing the claims. Regarding the apparatus in the above embodiment, specific manners in which the respective modules perform operations have been described in detail in the embodiments related to the method, and will not be explained in detail here.

1. A voice recognition method, wherein the method comprises:
encoding received voice data to obtain an acoustic vector sequence corresponding to the voice data, wherein the acoustic vector sequence comprises an acoustic vector of each audio frame of the voice data;
obtaining, according to the acoustic vector sequence and a first prediction model, an information amount sequence corresponding to the voice data and a first probability sequence corresponding to the voice data, wherein the information amount sequence comprises an information amount of each audio frame, and the first probability sequence comprises a first text probability distribution of each predicted character corresponding to the voice data;
obtaining a second probability sequence according to the acoustic vector sequence and a second prediction model, wherein the second probability sequence comprises a text probability distribution of each audio frame;
determining a target probability sequence according to the first probability sequence and the second probability sequence, wherein the target probability sequence comprises a target text probability distribution of each predicted character;
determining a target text corresponding to the voice data according to the target probability sequence.

2. The method according to claim 1, wherein the obtaining, according to the acoustic vector sequence and a first prediction model, an information amount sequence corresponding to the voice data and a first probability sequence corresponding to the voice data comprises:
inputting the acoustic vector sequence to the first prediction model to obtain the information amount sequence;
combining the acoustic vectors of the audio frames in the acoustic vector sequence according to the information amount sequence to obtain a character acoustic vector sequence, wherein the character acoustic vector sequence comprises an acoustic vector corresponding to each predicted character;
decoding the character acoustic vector sequence to obtain the first probability sequence.

3. The method according to claim 1, wherein the obtaining a second probability sequence according to the acoustic vector sequence and a second prediction model comprises:
inputting the acoustic vector sequence to the second prediction model to obtain a prediction probability distribution of each audio frame;
for each audio frame, deleting a probability, corresponding to a preset character, in the prediction probability distribution of the audio frame, and normalizing a prediction probability distribution obtained after deletion to obtain a text probability distribution of the audio frame.

4. The method according to claim 1, wherein the determining a target probability sequence according to the first probability sequence and the second probability sequence comprises:
combining the text probability distributions of the audio frames in the second probability sequence according to the information amount sequence to obtain a third probability sequence, wherein the third probability sequence comprises a second text probability distribution of each predicted character;
determining the target probability sequence according to the first probability sequence and the third probability sequence.

5. The method according to claim 4, wherein the combining the text probability distributions of the audio frames in the second probability sequence according to the information amount sequence to obtain a third probability sequence comprises:
traversing information amounts in the information amount sequence according to a sequential order, and grouping the audio frames according to cumulative sums of the information amounts to obtain a plurality of audio frame combinations, wherein the cumulative sums of the information amounts corresponding to other audio frame combinations except for the last audio frame combination are the same, and each audio frame combination corresponds to one predicted character;
for each audio frame combination, determining a weighted sum of the text probability distribution of each audio frame in the audio frame combination as the second text probability distribution of the predicted character corresponding to the audio frame combination, wherein a weight corresponding to each audio frame is determined based on the information amount that the audio frame belongs to the audio frame combination.

6. The method according to claim 4, wherein the determining the target probability sequence according to the first probability sequence and the third probability sequence comprises:
for each predicted character, determining a weighted sum of the first text probability distribution of the predicted character in the first probability sequence and the second text probability distribution of the predicted character in the third probability sequence as a target probability distribution of the predicted character.

7. The method according to claim 1, wherein the first prediction model is a Continuous Integrate-and-Fire (CIF) model, and the second prediction model is a Connectionist Temporal Classification (CTC) model.

8. (canceled)

9. A non-transitory computer-readable medium, storing a computer program, wherein the program, when executed by a processing apparatus, achieves the steps of:
encoding received voice data to obtain an acoustic vector sequence corresponding to the voice data, wherein the acoustic vector sequence comprises an acoustic vector of each audio frame of the voice data;
obtaining, according to the acoustic vector sequence and a first prediction model, an information amount sequence corresponding to the voice data and a first probability sequence corresponding to the voice data, wherein the information amount sequence comprises an information amount of each audio frame, and the first probability sequence comprises a first text probability distribution of each predicted character corresponding to the voice data;
obtaining a second probability sequence according to the acoustic vector sequence and a second prediction model, wherein the second probability sequence comprises a text probability distribution of each audio frame;
determining a target probability sequence according to the first probability sequence and the second probability sequence, wherein the target probability sequence comprises a target text probability distribution of each predicted character;
determining a target text corresponding to the voice data according to the target probability sequence.

10. An electronic device, comprising:
a storage apparatus, storing a computer program;
a processing apparatus, configured to execute the computer program in the storage apparatus to achieve the steps of:
encoding received voice data to obtain an acoustic vector sequence corresponding to the voice data, wherein the acoustic vector sequence comprises an acoustic vector of each audio frame of the voice data;
obtaining, according to the acoustic vector sequence and a first prediction model, an information amount sequence corresponding to the voice data and a first probability sequence corresponding to the voice data, wherein the information amount sequence comprises an information amount of each audio frame, and the first probability sequence comprises a first text probability distribution of each predicted character corresponding to the voice data;
obtaining a second probability sequence according to the acoustic vector sequence and a second prediction model, wherein the second probability sequence comprises a text probability distribution of each audio frame;
determining a target probability sequence according to the first probability sequence and the second probability sequence, wherein the target probability sequence comprises a target text probability distribution of each predicted character;
determining a target text corresponding to the voice data according to the target probability sequence.

11. The electronic device according to claim 10, wherein the obtaining, according to the acoustic vector sequence and a first prediction model, an information amount sequence corresponding to the voice data and a first probability sequence corresponding to the voice data comprises:
inputting the acoustic vector sequence to the first prediction model to obtain the information amount sequence;
combining the acoustic vectors of the audio frames in the acoustic vector sequence according to the information amount sequence to obtain a character acoustic vector sequence, wherein the character acoustic vector sequence comprises an acoustic vector corresponding to each predicted character;
decoding the character acoustic vector sequence to obtain the first probability sequence.

12. The electronic device according to claim 10, wherein the obtaining a second probability sequence according to the acoustic vector sequence and a second prediction model comprises:
inputting the acoustic vector sequence to the second prediction model to obtain a prediction probability distribution of each audio frame;
for each audio frame, deleting a probability, corresponding to a preset character, in the prediction probability distribution of the audio frame, and normalizing a prediction probability distribution obtained after deletion to obtain a text probability distribution of the audio frame.

13. The electronic device according to claim 10, wherein the determining a target probability sequence according to the first probability sequence and the second probability sequence comprises:
combining the text probability distributions of the audio frames in the second probability sequence according to the information amount sequence to obtain a third probability sequence, wherein the third probability sequence comprises a second text probability distribution of each predicted character;
determining the target probability sequence according to the first probability sequence and the third probability sequence.

14. The electronic device according to claim 13, wherein the combining the text probability distributions of the audio frames in the second probability sequence according to the information amount sequence to obtain a third probability sequence comprises:
traversing information amounts in the information amount sequence according to a sequential order, and grouping the audio frames according to cumulative sums of the information amounts to obtain a plurality of audio frame combinations, wherein the cumulative sums of the information amounts corresponding to other audio frame combinations except for the last audio frame combination are the same, and each audio frame combination corresponds to one predicted character;
for each audio frame combination, determining a weighted sum of the text probability distribution of each audio frame in the audio frame combination as the second text probability distribution of the predicted character corresponding to the audio frame combination, wherein a weight corresponding to each audio frame is determined based on the information amount that the audio frame belongs to the audio frame combination.

15. The electronic device according to claim 13, wherein the determining the target probability sequence according to the first probability sequence and the third probability sequence comprises:
for each predicted character, determining a weighted sum of the first text probability distribution of the predicted character in the first probability sequence and the second text probability distribution of the predicted character in the third probability sequence as a target probability distribution of the predicted character.

16. The electronic device according to claim 9, wherein the first prediction model is a Continuous Integrate-and-Fire (CIF) model, and the second prediction model is a Connectionist Temporal Classification (CTC) model.

17. The non-transient computer-readable medium according to claim 9, wherein the obtaining, according to the acoustic vector sequence and a first prediction model, an information amount sequence corresponding to the voice data and a first probability sequence corresponding to the voice data comprises:
inputting the acoustic vector sequence to the first prediction model to obtain the information amount sequence;
combining the acoustic vectors of the audio frames in the acoustic vector sequence according to the information amount sequence to obtain a character acoustic vector sequence, wherein the character acoustic vector sequence comprises an acoustic vector corresponding to each predicted character;
decoding the character acoustic vector sequence to obtain the first probability sequence.

18. The non-transient computer-readable medium according to claim 9, wherein the obtaining a second probability sequence according to the acoustic vector sequence and a second prediction model comprises:
inputting the acoustic vector sequence to the second prediction model to obtain a prediction probability distribution of each audio frame;
for each audio frame, deleting a probability, corresponding to a preset character, in the prediction probability distribution of the audio frame, and normalizing a prediction probability distribution obtained after deletion to obtain a text probability distribution of the audio frame.

19. The non-transient computer-readable medium according to claim 9, wherein the determining a target probability sequence according to the first probability sequence and the second probability sequence comprises:
combining the text probability distributions of the audio frames in the second probability sequence according to the information amount sequence to obtain a third probability sequence, wherein the third probability sequence comprises a second text probability distribution of each predicted character;
determining the target probability sequence according to the first probability sequence and the third probability sequence.

20. The non-transient computer-readable medium according to claim 19, wherein the combining the text probability distributions of the audio frames in the second probability sequence according to the information amount sequence to obtain a third probability sequence comprises:
traversing information amounts in the information amount sequence according to a sequential order, and grouping the audio frames according to cumulative sums of the information amounts to obtain a plurality of audio frame combinations, wherein the cumulative sums of the information amounts corresponding to other audio frame combinations except for the last audio frame combination are the same, and each audio frame combination corresponds to one predicted character;
for each audio frame combination, determining a weighted sum of the text probability distribution of each audio frame in the audio frame combination as the second text probability distribution of the predicted character corresponding to the audio frame combination, wherein a weight corresponding to each audio frame is determined based on the information amount that the audio frame belongs to the audio frame combination.

21. The non-transient computer-readable medium according to claim 19, wherein the determining the target probability sequence according to the first probability sequence and the third probability sequence comprises:
for each predicted character, determining a weighted sum of the first text probability distribution of the predicted character in the first probability sequence and the second text probability distribution of the predicted character in the third probability sequence as a target probability distribution of the predicted character.
